(19) United States
(12) Patent Application Publication
(10) Pub. No.: US 2019/0322016 A1
(43) Pub. Date: Oct. 24, 2019

(54) METHOD FOR BONDING INJECTION MOLDED PLASTICS

(71) Applicant: FORD GLOBAL TECHNOLOGIES, LLC, Dearborn, MI (US)

(72) Inventors: LARRY PAUL HAACK, ANN ARBOR, MI (US); ANN MARIE STRACCIA, SOUTHGATE, MI (US); SABRINA LOUISE PECZONCZYK, ANN ARBOR, MI (US)

(21) Appl. No.: 15/960,022

(22) Filed: Apr. 23, 2018

(51) Int. Cl. B29C 45/14; B32B 17/06

(52) U.S. Cl. CPC B29C 45/14311; B32B 17/064; B29C 45/14819; B29K 2105/0005; B29C 45/14434; B29C 2045/14868; B29C 45/14778

(57) ABSTRACT

According to an embodiment, a method of bonding an injection molded plastic to a glass substrate is disclosed. The method includes applying a silica coating to a surface of the glass substrate; injection-molding a plastic substrate, modified with a silane coupling agent, on to the glass substrate to adhere the plastic substrate to the surface; and curing the plastic substrate to covalently bond the silane coupling agent to the silica coating.

### TECHNICAL FIELD

The present disclosure relates to bonding a glass substrate with an over-molded plastic.

### BACKGROUND

Encapsulated glass provides protection for electrical components from environmental exposure, as well as framing for automotive applications. Thermoplastics and thermosetting plastics can be injection molded on to a glass substrate to encapsulate the glass. Robust adhesion of the molded plastic to glass is necessary to ensure bond integrity and to prevent air and water leakage from fouling the insulated electrical components or entering the vehicle cabin.

Methods for bonding injection molded plastics to glass to form the encapsulated glass include adding a primer to the glass substrate surface prior to injection molding. The primer promotes chemical linkage and bonding between the plastic and glass surface. Solvent-borne primers for promoting bonding are applied by hand, rendering the application prone to human error. Furthermore, the solvent-borne primers contain volatile organic compounds (VOCs) that may require ventilation in the working environment.

### SUMMARY

According to an embodiment, a method of bonding an injection molded plastic to a glass substrate is disclosed. The method includes applying a silica coating to a surface of the glass substrate; injection-molding a plastic substrate, modified with a silane coupling agent, on to the glass substrate to adhere the plastic substrate to the surface; and curing the plastic substrate to covalently bond the silane coupling agent to the silica coating.

In one or more embodiments, applying the silica coating may include depositing the silica coating by an atmospheric pressure air plasma jet. Further, depositing the silica coating may include diluting hexamethyldisiloxane with a compatible gas. In some embodiments, the silica coating may include silanol groups configured to link with the silane coupling agent of the plastic substrate. According to one or more embodiments, curing the plastic substrate may form siloxane linkages between the silane coupling agent and the silica coating. In one or more embodiments, the glass substrate may include an enamel frit on the surface. The method may further comprise cleaning the surface prior to applying the silica coating. In certain embodiments, the plastic substrate may be a thermoset plastic or a thermoplastic.

According to an embodiment, an encapsulated glass system is disclosed. The glass system includes a glass substrate having a surface, a silica coating on the surface, and a plastic substrate modified with a silane coupling agent. The plastic substrate is injection molded directly on to the surface such that the silane coupling agent is covalently bonded to the silica coating.

In one or more embodiments, the silica coating may be an atmospheric pressure air plasma jet induced silica coating. Further, the air plasma jet induced silica coating may include silanol groups configured to link with the silane coupling agent. According to one or more embodiments, the silica coating may be a hexamethyldisiloxane coating. In some embodiments, the glass substrate may include an enamel frit on the surface.

According to an embodiment, a method for bonding an injection molded plastic to a glass substrate is disclosed. The method includes spraying a silica coating on to a surface of a glass substrate to form a bondable surface, injection-molding a plastic modified with a silane coupling agent directly to the bondable surface to adhere the plastic to the substrate, and curing the plastic to covalently bond the silane coupling agent of the plastic with the silica coating.

In one or more embodiments, the method may further include forming an enamel frit on the surface of the glass substrate before spraying the silica coating. In some embodiments, spraying the silica coating may include forming silanol groups at the bondable surface to link with the silane coupling agent. Further, the silanol groups may form siloxane linkages with the silane coupling agent. In one or more embodiments, the method may further include cleaning the surface by air plasma jet spray before applying the silica coating. In some embodiments spraying the silica coating may include diluting hexamethyldisiloxane with a compatible gas. According to one or more embodiments, spraying the silica coating may include depositing the silica coating by an atmospheric pressure air plasma jet.

### BRIEF DESCRIPTION OF THE DRAWINGS

FIG. 1A shows a schematic cross-section of a glass system, according to an embodiment;

FIG. 1B shows a schematic cross-section of a glass system, according to another embodiment;

FIG. 2 is a schematic diagram of applying a coating to a glass substrate;

FIG. 3 is a schematic diagram of forming a chemical linkage in a glass system, according to an exemplary embodiment;

FIG. 4 is a schematic diagram of forming a chemical linkage in a glass system, according to another exemplary embodiment;

FIG. 5A is a schematic diagram of a process for forming a glass system, according to an embodiment;

FIG. 5B is a schematic diagram of a process for forming a glass system, according to another embodiment;

FIG. 6A is a schematic diagram of a process for forming a glass system, according to yet another embodiment; and

FIG. 6B is a schematic diagram of a process for forming a glass system, according to another embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Automotive glass, for example, the windshield and backlite, is typically bonded to the vehicle frame using an adhesive. One example of a common adhesive is a moisture-cured urethane adhesive. The glass may be decorated on the inside perimeter with an enamel frit in order to mask the appearance of the adhesive bead, as well as to protect the adhesive bond to the glass from UV radiation damage. The adhesive may bond directly to the painted body frame, or use a primer. The adhesive may bond to the glass enamel frit also by means of a primer. The primer used between the glass and the adhesive may be different from the primer used between the adhesive and the vehicle frame, depending on the paint chemistry of the components. Examples of typical primers may include manually applied solvent-borne silane-based primers. Although solvent-borne primers provide improved bonding, adhesive failure and cohesive failure can occur between primed substrates and the adhesives. Failure may occur if the glass surface is contaminated such that the primer is prevented from bonding to the surface, or if the primer is inadequately applied or not applied at the correct location. A good bond between the glass and/or enamel frit and the vehicle frame is important to ensure the glass is well-adhered to the vehicle.

The present disclosure relates to applying a plasma induced silica coating to functionalize the glass surface chemistry, and directly applying a modified injection molded (or over-molded) thermoplastic or thermoset plastic (hereinafter plastic or plastic substrate) to the glass surface, which is durably bonded to the glass via the silica coating after curing. The plastic is modified to include a silane coupling agent to ensure a durable chemical bond between the functionalized glass and the injection molded plastic when cured. The silane coupling agent forms a siloxane linkage (Si—O—Si) with silanol groups (Si—OH) in the silica coating. Further, the plasma induced coating cleans the glass while depositing the coating in an automated manner, thus removing potential contamination of the glass surface, minimizing human error, and reducing adhesive and cohesive failure which stems therefrom. The present disclosure provides for a method such that VOC emitting primers are removed from the bonding process and durable covalent bonding between the glass and over-molded plastic is achieved.

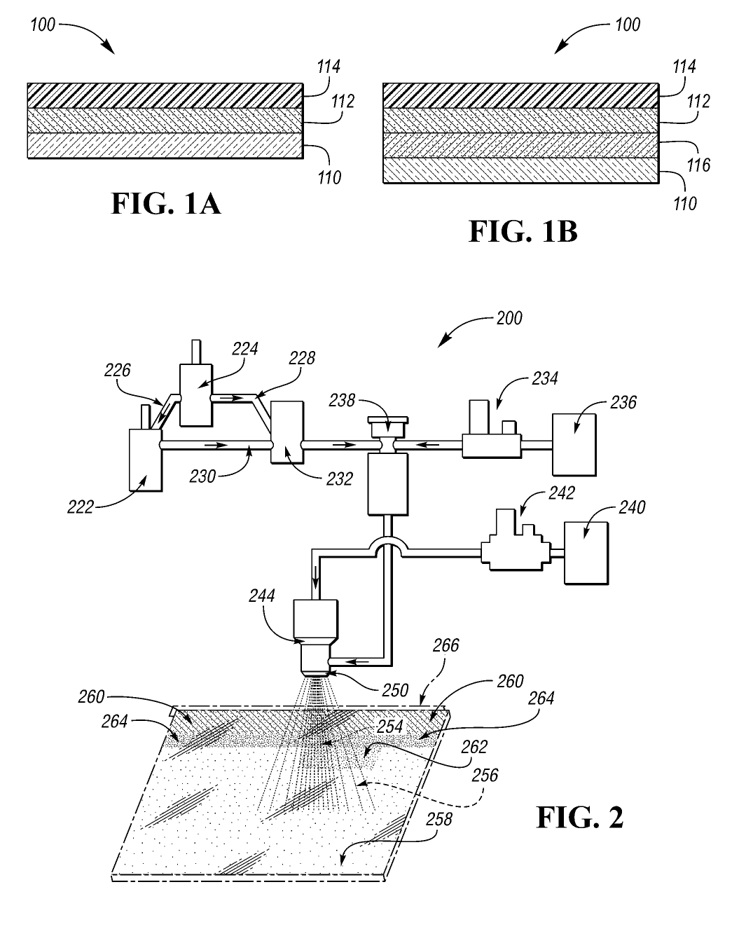

With references to FIG. 1A, a schematic cross-section of an encapsulated glass system 100, according to an embodiment, is shown. The glass system 100 may be an automotive glass assembly, such as a front or rear windshield, side windows, moonroofs, panoramic roofs, or light assemblies. However, the system 100 may represent any glass assembly where a piece of glass is bonded to an underlying substrate. The system may include a sheet of glass 110 that is to be bonded to an over-molded or injection-molded thermoplastic or thermoset plastic (plastic) substrate 114, hereinafter “plastic substrate.” Hereinafter, over-molded and injection-molded are used interchangeably for describing the plastic substrate which is formed directly on the glass substrate via injection- (or over-) molding. The plastic substrate may be any vehicle component requiring bonding to a glass surface. The encapsulated glass system 100 further includes a silica coating 112 applied to the glass 110. The silica coating 112 may be an atmospheric air plasma jet induced silica coating. Although air-plasma is referred to hereinafter, the gas for the plasma jet may be any compatible gas, and an atmospheric pressure air plasma jet forming an air-plasma induced coating is suggested for illustrative purposes. The silica coating 112 forms a bondable surface on the glass 110. The plastic substrate 114 is modified with a silane coupling agent, in order to promote chemical bonding with the silica coating 112. As silanol groups in the silica coating 112 link with the silane coupling agent in the plastic substrate 114 during curing, the glass 110 is covalently bonded with plastic substrate 114. The chemical link may be, but is not limited to, a siloxane linkage.

In some embodiments, as shown in FIG. 1B, an encapsulated glass system 100 may further include an enamel frit 116. The enamel frit 116 may be coated on the glass 110. In general, an enamel frit is a layer of fused powdered glass applied to the glass 110 by firing. Enamel frits are known in the art and will not be described in detail. Non-limiting examples of automotive glasses, enamel frits are disclosed in commonly owned U.S. Pat. Nos. 7,517,561, 7,744,984, 8,048,530, 8,197,909, and 8,865,264, the disclosures of which are hereby incorporated in their entirety by reference herein. The silica coating 112 is applied to the enamel frit 116 on the glass 110. The plastic substrate 114 is then molded onto the system 100 such that the silane coupling agent in the plastic substrate 114 bonds to the silica coating 112.

The glass system 100 may also optionally include an adhesive (not shown) to improve bonding. The adhesive may be any type of adhesive, such as, but not limited to, a urethane adhesive (e.g., moisture-cured). The adhesive may be used to enhance bonding of the enamel frit 116 to the plastic substrate 114 (e.g., vehicle components). As such, an adhesive bond may exist between the adhesive, the enamel frit 116, and plastic substrate 114. While the adhesive may contact the enamel frit 116 or plastic substrate 114 directly, the plastic substrate 114 or glass 110 may have any additional coating(s) thereon, such as paint and/or a primer. A primer may improve the bonding between the enamel frit 116 and the adhesive. Non-limiting examples of types of primers include solvent-borne primers, plasma-deposited primers, silica primers, or combinations thereof. Air plasma-activated silica (APASi) primers, and non-limiting examples thereof, are described in the above incorporated references.

Referring to FIG. 2, a schematic diagram of an atmospheric pressure air plasma (APAP) system 200 is shown for depositing the silica coating for the encapsulated glass system. A polymerizable material, such as hexamethyldisiloxane (HMDSO) in the form of prepolymer in a feedstock vessel 22 is supplied in tube 30 metered using a mass flow controller 32 and vaporized and mixed with a carrier gas in mixing chamber 38. This material forms the silica coating, and forms silanol (—SiOH) groups on the surface. The carrier gas, such as air, is supplied from a carrier gas feedstock vessel 36 and introduced through a meter 34 into mixing chamber 38. This mixture is introduced into an atmospheric pressure air plasma apparatus 44 containing the plasma of ionized gas. The ionization gas comes from the ionization gas feedstock vessel 40 through a meter 42. The ambient air pressure around the air plasma apparatus ranges from greater than 50 kilopascals, 75 kilopascals, or 100 kilopascals and less than 300 kilopascals, 250 kilopascals, 200 kilopascals, or 150 kilopascals. At the exit nozzle 50, the high-velocity plasma reaction coating may achieve velocities greater than 10-m/s, 50-m/s, or 75-m/s, and less than 200-m/s, 150-m/s, or 125-m/s. The gases exiting the nozzle 50 at a temperature less than 450° C., 400° C., 350° C., 325° C., or 300° C. and greater than 70° C., 100° C., 125° C., or 150° C.; while the temperature of the substrate may be less than 95° C., 85° C., 75° C., 70° C., 65° C., 60° C., 55° C., or 50° C., depending upon the conditions of operation. This temperature at the substrate allows this process to work with substrates that are susceptible to heat damage.

The gases from the exit nozzle 50 form a spray pattern with the outer penumbra 56 having mostly ionized gas for cleaning and/or activating. Closer to the center of the spray pattern is the area of the higher concentration 54 of silica coating material. The surface 58 receiving the silica coating material 62 may be an automotive glass 28 having a ceramic frit 60 and tinted glass 64. The automotive glass 28 is shown encapsulated within a frame 66.

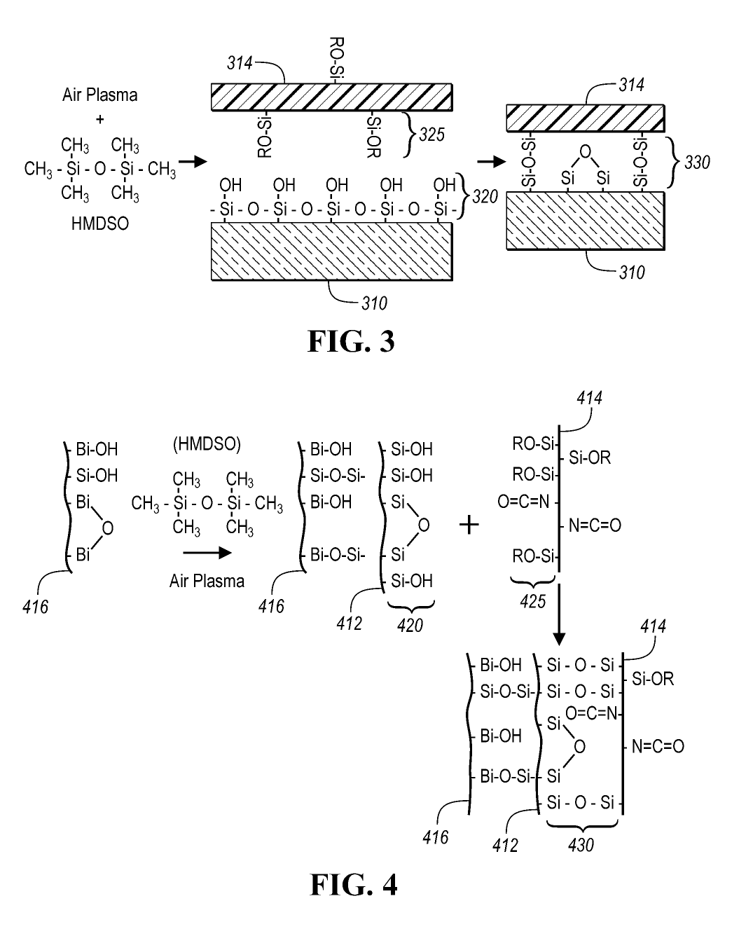

Referring to FIG. 3, a schematic process diagram of an exemplary chemical linkage is shown. As shown in FIG. 3, the HMDSO and air plasma form a silica coating on the glass 310. An air-plasma mixture is shown for illustrative purposes, as other compatible gases may be used for diluting the HMDSO. The silica coating provides silanol groups 320 on the surface of the glass 310. After the APAP deposition of the silica coating, the thermoset plastic or thermoplastic substrate 314 (plastic substrate), including the silane coupling agent 325, is over-molded directly onto the surface-modified glass 310 by injection molding. Thus, the silanol groups 320 on the glass 310 deposited by APAP in the silica coating are chemically linked to the plastic substrate 314 via the silane coupling agent 325 such that siloxane linkages 330 are formed. As such, a durable chemical bond forms between the plastic substrate 314 and the glass 310.

Referring to FIG. 4, a schematic process diagram of an exemplary chemical linkage when the glass system includes an enamel frit 416. Enamel frit 416 has the air-plasma and HMDSO deposited on the surface to form the silica coating 412 on the frit 416. The silanol groups 420 of the silica coating 412 may form a chemical bond with the enamel frit 416. When plastic substrate 414, modified with silane coupling agent 425, is over-molded on to the enamel frit 416, covalent bonds form between the silanol groups 420 and the silane coupling agent 425. The bonded glass system may form siloxane linkages 430 between the frit 416 and the plastic substrate 414, which results in a durable chemical bond.

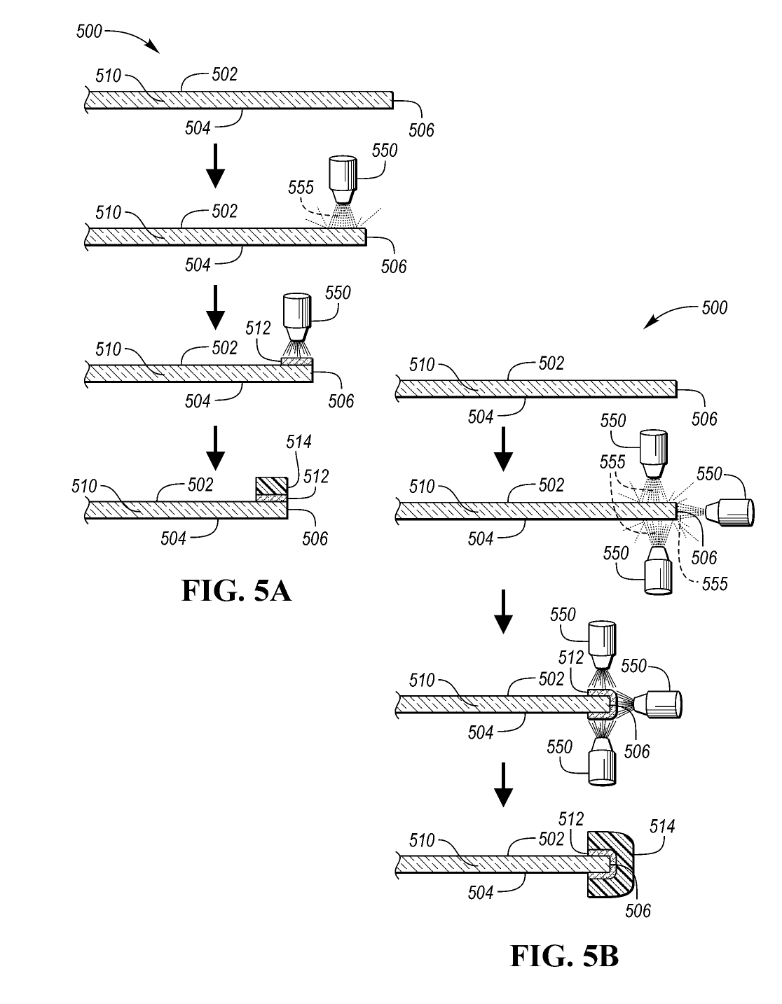

Referring to FIGS. 5A & 5B. a schematic process 500 for depositing a silica coating and bonding a plastic substrate by injection-molding directly onto the glass is shown. Glass 510 may have interior and exterior surfaces 502, 504, respectively. Glass 510 may also have an edge 506. The interior surface 502 or of the glass 510 may be cleaned by atmospheric air plasma jet 550.

The surface of glass 510 to receive the silica coating 512 may be activatable by ionization and heat and may be in pristine condition, have a covering of debris, or be corroded. The surface may be cleaned, and partially activated, by an atmospheric pressure air plasma 550. Possible cleaning and activation mechanisms of an atmospheric pressure air plasma by itself may include repair of alkali depleted layers of weathered glass, ionization of the surface, modification of the surface energy, combustion of oils and dust or combinations thereof. When the atmospheric pressure air plasma is also a device depositing high-velocity impact plasma coatings of one embodiment of this invention, the penumbra of the atmospheric pressure air plasma exiting from the nozzle may have a cleaning function associated with the ionization and heat. Accordingly, in this embodiment, the time period between of the cleaning and/or activation step and the deposition step is greater than 1 μs, 5 μs, 10 μs, 25 μs, or 100 μs. The cleaning and/or activating operation may be capable of operating at higher travel speeds than the deposition operation or a combined cleaning and/or activating as well as a deposition operation. Other aspects of these embodiments may include having the cleaning operation using broader width passes and the deposition operation using their raster-type passes. The cleaning and/or activating operation may be accomplished using other ionization technologies such as corona discharge or combustion sources. According to an embodiment, the time periods between the cleaning/activation step and deposition is greater than 0.1 second, 1 s, 5 s, 10 s, 25 s, or 100 s and less than 150 s, 300 s, 10 minutes, 30 min, 1 hour, 12 hr, 1 day, 2 days, or 5 days. Additional cleaning steps may be performed to clean the plasma silica coating after an amount of time, such as after storage.

Although plasma cleaning is shown as a separate step, cleaning the surface and coating may also be done in one step without compromising adhesion performance of the glass 510 with the plastic substrate 514, or omitted. Furthermore, as depicted in FIG. 5B, one or more separate atmospheric pressure air plasmas 550 may be used to clean and/or activate one or more of the glass 510 surface, such as the interior 502, exterior 504, and edge 506. The cleaning/activation 555 by the one or more atmospheric pressure air plasmas 550 may be followed by one or more separate atmospheric pressure air plasmas 550 depositing high velocity impact plasma coatings, such as the silica coating 512. After the silica coating 512 is deposited on the glass 510, the plastic substrate 514 is injection-molded directly onto the silica coating 512 on the glass 510. Plastic substrate 514 is modified with the silane coupling agent to provide a durable bond for the glass system.

As shown in FIG. 5A, the silica coating 512 is only applied to the interior surface 502. This is not intended to be limiting, as the silica coating 512 may be applied to any combination of one or more of the glass surfaces. In some embodiments, as shown in FIG. 5B, the silica coating 512 may be applied to the interior surface 502, exterior surface 504, and edge 506 of the glass 510. The APAPs 550 may be operated in a sequential manner, in a parallel manner, or a combination thereof. When operated as a parallel set of multi-APAPs 550 typical spacing may be about 2 mm.

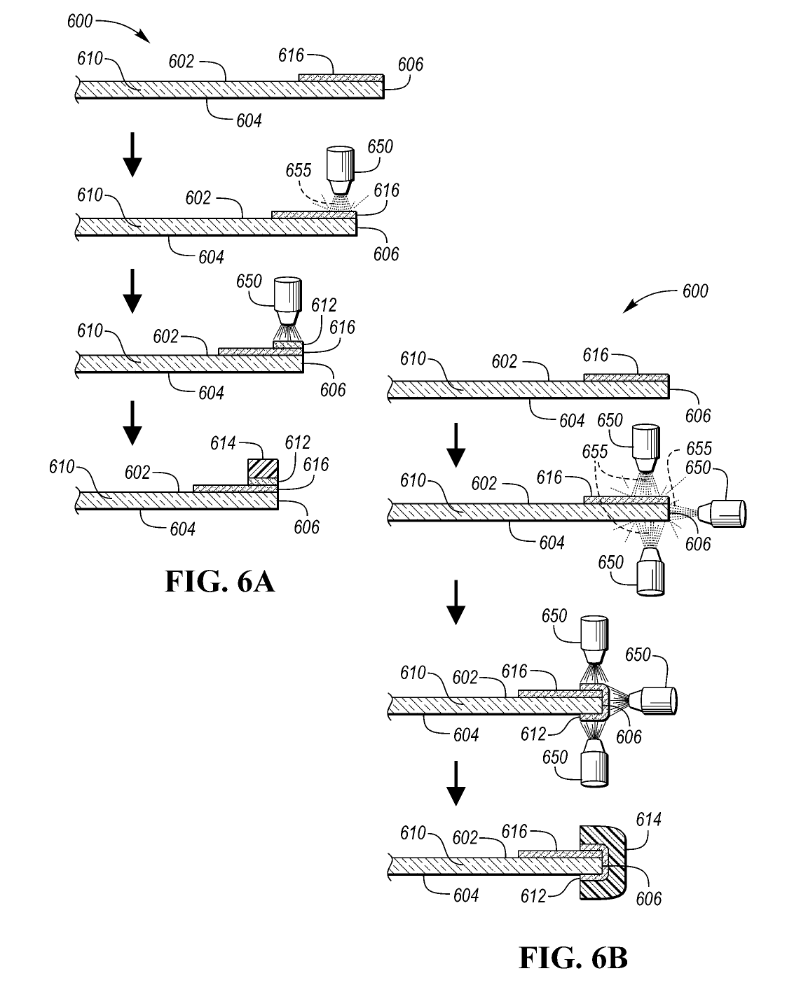

Similar to FIGS. 5A & 5B, FIGS. 6A & 6B show a schematic process 600 of depositing a silica coating and injection-molding a plastic substrate, but show depositing the silica coating on an enamel frit instead of glass.

Glass 610 may have interior and exterior surfaces 602, 604, respectively. Glass 610 also may have an edge 606. The glass 610 has an enamel frit 616 disposed on at least one of the surfaces 602, 604, 606. Although shown on the interior surface 602, the enamel frit 616 may be on one more or more of the surfaces, and the enamel frit 616 location in FIGS. 6A and 6B is for illustrative purposes. The interior surface 602 of the glass 610 and enamel frit 616 may be cleaned and/or activated by atmospheric air plasma jet 650. As previously discussed, and as shown in FIG. 6B, multiple surfaces of the glass 610 may be cleaned by air plasma jets 650. Although plasma cleaning is shown in FIGS. 6A & 6B as a separate step, cleaning and coating may also be done in one step without compromising adhesion performance of the glass 610 with the plastic substrate 614, or omitted.

Furthermore, as depicted in FIG. 6B, one or more separate atmospheric pressure air plasmas 650 may be used to clean and/or activate one or more of the glass 610 or enamel frit 616 surface, such as the interior 602, exterior 604, and edge 606 of glass 610. The cleaning/activation 655 by the one or more atmospheric pressure air plasmas 650 may be followed by one or more separate atmospheric pressure air plasmas 650 depositing high velocity impact plasma coatings, such as the silica coating 612 onto the enamel frit 616. After the silica coating 612 is deposited on the enamel frit 616, the plastic substrate 614 is injection-molded directly onto the silica coating 612 on the enamel frit 616 of glass 610. Plastic substrate 614 is modified with the silane coupling agent to provide a durable bond for the glass system.

As shown in FIG. 6A, the silica coating 612 is only applied to the interior surface 502 including the enamel frit 616. This is not intended to be limiting, as the silica coating 612 may be applied to any combination of one or more of the glass surfaces, regardless of whether an enamel frit 616 is on the glass, as shown in FIG. 6B. In some embodiments, as shown in FIG. 6B, the silica coating 612 may be applied to the interior surface 602, exterior surface 604, and edge 606 of the glass 610, regardless of whether there is enamel frit 616 on the glass 610. The APAPs 650 may be operated in a sequential manner, in a parallel manner, or a combination thereof. When operated as a parallel set of multi-APAPs 650 typical spacing may be about 2 mm.

As such, a durable chemical bond can be formed between an injection-molded (or over-molded) plastic substrate modified with a silane coupling agent and a silica coating deposited on a glass surface. The glass surface may or may not include an enamel frit. The silica coating provides silanol groups that covalently bond with the silane coupling agent of the plastic substrate, thus forming a durable chemical bond for the bonded glass assembly.

As can be inferred by one skilled in the art, portions of the process may be performed in two or more locations, for example, at a supplier location and at an OEM location. One of ordinary skill in the art will understand, based on the present disclosure, that certain steps may be performed at either location and that the order of the steps may differ from those described and shown. Certain steps may also be repeated.

### Experimental Section

Experiments were conducted to test the effectiveness of 1) employing a silane coupling agent in a urethane adhesive and 2) using an air plasma induced silica coating to enhance adhesive bonding to an enamel frit. These experiments are projected to yield analogous results to over-molding a thermoplastic or thermoset plastic containing an appropriate silane coupling agent onto a ceramic frit for bonding with the air plasma induced silica coating.

Automotive glass of dimension 3½×5 inches with different ceramic frit glazings were obtained (Glass 1, Glass 2, and Glass 3). The frit surfaces were treated with 30 g/h hexamethyldisiloxane (HMDSO), diluted with 5 L/min air, injected into an atmospheric pressure air plasma (APAP) ionization source flowing at 30 L/min. A diagram of this apparatus is shown in FIG. 2.

The reactive mixture was applied to the glass robotically at a treatment distance of 8 mm with a velocity of 600 mm/s in a raster pattern at a spacing of 2 mm between passes. Atmospheric pressure air plasma pre-cleaning, prior to the application of HMDSO, was accomplished at a velocity of 25 mm/s at the same treatment distance and raster pattern. The chemically modified glass was assessed for adhesion to a glass bonding urethane and a modified urethane adhesive. The glass bonding urethane is a moisture curing one-component urethane adhesive containing no silane coupling agent, while the modified urethane adhesive contains a nominal amount of a silane coupling agent to chemically link up to silanol (—SiOH) groups.

Bond strength was assessed by conducting the quick knife adhesion (QKA) test according to Ford Laboratory Test Method BU 154-01. Beads of adhesive were applied to each frit, allowed to cure, and then pulled while cutting diagonally with a razor blade in order to direct load forces towards the adhesive/substrate interface. Results under 3 conditions are given in the table below. Note that AF (adhesive failure) denotes no bond or chemical link between substrate and adhesive, while CF (cohesive failure) indicates that a strong bond to substrate was achieved forcing de-adhesion to occur within the urethane adhesive.

TABLE 1

| | | Glass 1 | | Glass 2 | | Glass 3 | |
|---|---|---|---|---|---|---|---|
| | | Glass | Modified | Glass | Modified | Glass | Modified |
| | | Bonding | Urethane | Bonding | Urethane | Bonding | Urethane |
| Treatment | Condition | Adhesive | Adhesive | Adhesive | Adhesive | Adhesive | Adhesive |
| None | 3 days RT | 100% AF | 100% AF | 100% AF | 100% AF | 100% AF | 100% AF |
| | 7 days RT | 100% AF | 100% AF | 100% AF | 100% AF | 100% AF | 100% AF |
| | 2 wks 98° C. | 20% AF | 100% CF | 100% AF | 100% CF | 100% AF | 100% CF |
| | 98% RH | | | | | | |
| Air plasma | 3 days RT | 100% AF | 100% AF | 100% AF | 50% CF | 100% AF | 100% AF |
| induced | 7 days RT | 100% AF | 50% CF | 100% AF | 50% CF | 100% AF | 50% CF |
| silica | 2 wks 98° C. | 100% AF | 100% CF | 100% AF | 100% CF | 100% AF | 100% CF |
| coating | 98% RH | | | | | | |

The moisture cured glass bonding urethane adhesive did not chemically bond to any of the enamel frits with or without the addition of an air plasma induced silica coating. The moisture-cured urethane adhesive was not able to chemically link up with oxides available on the surface of the ceramic frits, nor to silanol functional groups (—SiOH) added with the air plasma induced silica coating. The modified urethane adhesive, containing the silane coupling agent, did not chemically link up to any of the ceramic frits directly at room temperature, but linked up fully after 2 weeks at 98° C. and 98% relative humidity. With addition of the air plasma induced silica coating, partial adhesion to Glass 2 occurred after 3 days at room temperature, partial adhesion to all frits occurred after 7 days at room temperature, and complete adhesion to all frits was realized after 2 weeks at 98° C. and 98% relative humidity.

According to embodiments of the present disclosure, an injection-moldable thermoset plastic or thermoplastic modified with a silane coupling agent and an air plasma induced silica coating is disclosed for an encapsulated glass system. The modified injection-molded plastic and silica coating improve adhesion of the plastic to enamel frits and/or the glass surface when compared to encapsulated glass assemblies without a silane coupling agent and an APAP deposited silica coating. This approach is applicable to injection-molding plastics directly on glass substrates coated with an air plasma induced silica coating, where the thermoplastic or thermoset plastic can be functionalized with the addition of a silane coupling agent to form a chemical covalent bond with the silica coating on the glass.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method of bonding an injection molded plastic to a glass substrate, the method comprising:
applying a silica coating to a surface of the glass substrate;
injection-molding a plastic substrate, modified with a silane coupling agent, on to the glass substrate to adhere the plastic substrate to the surface; and
curing the plastic substrate to covalently bond the silane coupling agent to the silica coating.

2. The method of claim 1, wherein applying the silica coating includes depositing the silica coating by an atmospheric pressure air plasma jet.

3. The method of claim 2, wherein depositing the silica coating includes diluting hexamethyldisiloxane with a compatible gas.

4. The method of claim 1, wherein the silica coating includes silanol groups configured to link with the silane coupling agent of the plastic substrate.

5. The method of claim 1, wherein curing the plastic substrate forms siloxane linkages between the silane coupling agent and the silica coating.

6. The method of claim 1, wherein the glass substrate includes an enamel frit on the surface.

7. The method of claim 1, further comprising cleaning the surface prior to applying the silica coating.

8. The method of claim 1, wherein the plastic substrate is a thermoset plastic or a thermoplastic.

9. An encapsulated glass system comprising:
a glass substrate having a surface;
a silica coating on the surface; and
a plastic substrate modified with a silane coupling agent and injection molded directly on to the surface such that the silane coupling agent is covalently bonded to the silica coating.

10. The encapsulated glass system of claim 9, wherein the silica coating is an atmospheric pressure air plasma jet induced silica coating.

11. The encapsulated glass system of claim 10, wherein the air plasma jet induced silica coating includes silanol groups configured to link with the silane coupling agent.

12. The encapsulated glass system of claim 9, wherein the silica coating is a hexamethyldisiloxane coating.

13. The encapsulated glass system of claim 9, wherein the glass substrate includes an enamel frit on the surface.

14. A method for bonding an injection molded plastic to a glass substrate, the method comprising:
spraying a silica coating on to a surface of a glass substrate to form a bondable surface;
injection-molding a plastic modified with a silane coupling agent directly to the bondable surface to adhere the plastic to the substrate; and
curing the plastic to covalently bond the silane coupling agent of the plastic with the silica coating.

15. The method of claim 14, further comprising forming an enamel frit on the surface of the glass substrate before spraying the silica coating.

16. The method of claim 14, wherein spraying the silica coating includes forming silanol groups at the bondable surface to link with the silane coupling agent.

17. The method of claim 16, wherein the silanol groups form siloxane linkages with the silane coupling agent.

18. The method of claim 14, further comprising cleaning the surface by air plasma jet spray before applying the silica coating.

19. The method of claim 14, wherein spraying the silica coating includes diluting hexamethyldisiloxane with a compatible gas.

20. The method of claim 14, wherein spraying the silica coating includes depositing the silica coating by an atmospheric pressure air plasma jet.
